(19) United States
(12) Patent Application Publication
(10) Pub. No.: US 2009/0194606 A1
(43) Pub. Date: Aug. 6, 2009

(54) Means of Atomizing a Fluid by Superheating and De-superheating it

(76) Inventor: Rabindra K. Sinha, McKees Rocks, PA (US)

Correspondence Address: RABINDRA K. SINHA, 609 HANCOCK COURT, MCKEES ROCKS, PA, 15136, US

(21) Appl. No.: 12/026,388

(22) Filed: Feb. 5, 2008

(51) Int. Cl. B05B 17/04; B01D 53/78; B05B 9/04

(52) U.S. Cl. 239/10; 422/169; 95/152; 423/210; 239/13

(57) ABSTRACT

This provides a method for producing fine particles of liquid or a mixture of liquids that contains dissolved solids in it. This particularly applies to solutions of salts that specially need to be added to gaseous streams at temperatures above ambient. The method can also be applied for producing very fine particles and aerosols of materials that are normally solid or liquid by selecting appropriate solvent, pressure and temperature.

### BACKGROUND OF THE INVENTION

In many applications of industrial importance it is desired to improve the interactions of two fluids or systems so that they intermingle with each other very well. This is generally accomplished when at least one interacting component is presented to the other in a very fine form. This is primarily required when high levels of mixing or dispersions are required to improve the rate of mixing, chemical reaction or general effectiveness. When the effectiveness of mixing or reaction of a liquid stream with a gaseous stream is required then it is generally accomplished by atomizing the liquid stream into the gaseous stream.

The process of atomization, according to the Encarta Dictionary (English, North America) is defined as a “transitive verb to reduce something to atoms or separate something into free atoms; or transitive verb to destroy something with atomic weapons; or transitive and intransitive verb to convert a liquid into fine particles, or to spray particles converted in this way”.

It is the last definition which is most commonly understood and used by consumers and engineers of industries alike. The most common example seen by everyday consumer is in use of spray cans and perfumes. Air, carbon dioxide or Freon is the liquid utilized to atomize paints, perfumes etc. Atomization where making the fluid to flow at high velocity through a narrow opening is termed atomization by mechanical means. Impingement of the fluid at high velocity on a static surface combines the modes of high velocity and impingement. In two-fluid atomization the kinetic energies (produced by the respective movements of the fluids) is imparted to the fluid desired for atomization. A very common example of this is atomization of liquids by compressed air or steam. Use of ultrasound, piezo-electricity, static electricity, etc., are other common examples by which atomization is accomplished.

Atomizing systems and equipment based on the above mentioned methods and principles have been commercial for many years and new modifications to existing methods and apparatuses are made almost daily. Atomization of liquids is of significant industrial importance as is evident from copious numbers of US and global patents issued since the beginning of the twentieth century.

This application is novel as it is based on a process that is different than disclosed before. It makes use of a physical property that is common for fluids such as gases, vapors, etc. The invention is described in detail in “Detailed Description of the Invention”.

### SUMMARY OF THE INVENTION

The invention relates to a novel method of atomizing fluids, particularly liquids such as water and/or water containing treatment chemicals present in water as solutes. The disclosed process of atomization can also be employed to produce very fine particles of materials that are normally solid at ambient conditions and/or liquids or solutions. The production of fine materials can be accomplished by selecting an appropriate fluid solvent and appropriate physical parameters such as pressure and temperature. The invention particularly relates to injection of treatment chemicals in a finely atomized and dispersed form of treatment chemicals in flue gases. Injection of fine form of chemicals in the flue gas is necessary for better and efficient control and removal of pollutant materials present in it. Treatment of flue gases with very fine treatment chemicals produced by the disclosed invention can be useful for removing contaminants such as mercury, fine ash particulates, particulates of sizes less than 2.5 microns, etc. The flue gas conditioning fluid is atomized by first superheating it to a temperature where it is maintained as a liquid at a high pressure and then releasing the aforementioned liquid to a low or atmospheric pressure through one or several small holes.

### DETAILED DESCRIPTION OF THE INVENTION

Electrostatic Precipitator (ESP) and Bag Houses are currently the most common technologies for controlling the emission of particulate materials such as fly ash, cement fines, catalyst fines, blast furnace fines, etc. In coal combustion such for generating steam in industrial and utility boilers, the coal ash fines known as fly ash is removed by these devices from the combustion gas commonly known as flue gas before its discharge from the stack.

The fly ash removal from the flue gas is governed by regulatory laws and for this reason its efficient and within specified limits is mandatory for a coal fired unit to operate. To meet compliance sometimes the efficiency of the particulate control devices such as ESP has to be improved. Such improvement in ESP efficiencies are obtained by what is known as flue gas conditioning which makes the ash particulates suitable for collection by the ESP. One common method of conditioning is by a gas such as sulfur trioxide and/or ammonia. Sometimes it is advantageous to use other chemical additives instead of sulfur trioxide, etc. These chemical additives are primarily water borne and consist of various salts, etc. dissolved in water. One such chemical formulation is available from ARKAY Technologies, 609 Hancock Court, McKees Rocks, Pa. 15136, which is also water based consisting of various salts etc., dissolved in water.

When water borne chemicals are used for flue gas conditioning, then it is normally applied as a fine mist which is accomplished by atomizing the formulation with compressed air or steam. Unfortunately, the atomized formulation does not completely vaporize in the flue gas duct. This causes interaction of the atomized particles with the fly ash present in the flue gas and causes a very undesirable deposition of ash on the duct walls and other internal structures of the duct.

The disclosed invention produces a stream of very fine particles with almost no water in it. It is visualized, although not to be construed as limiting, that the water present in the solution that leaves the injection lance as atomized mist is almost instantly converted to a mixture primarily of steam and particles of formulation in its dry state, the state that was utilized to make the formulation by dissolving it in water in the first place. Since there is very little water in the atomized mist/formulation and all the liquid becomes steam the ash deposition potential is considerably removed.

It is anticipated that materials that go into a vapor phase at some plausible temperatures and has the properties of being a solvent for certain solutes of import, then such materials can also be gainfully employed. Although water is the cheapest vehicle to make formulations for the instant example of flue gas conditioning other solvents or vehicles can also be employed. Examples given below illustrate the point.

### EXAMPLE 1

The formulation provided by ARKAY Tech for conditioning flue gas was metered into a special injection lance as described here. The lance was a normal piece of ¼″ stainless steel pipe coil fitted with a commercial nozzle designated as PJ series nozzle provided by Bete Fog Nozzle Inc, 50 Greenfield Street, Greenfield Mass. 01302. However this lance-nozzle assembly was modified by inserting another piece of pipe upstream of the nozzle (between the nozzle and the lance body) that contained in it a compression spring and a steel ball. The compression spring which is available from many wire spring suppliers and their distributors was rated for 150 psi. In other words the steel ball that kept the lance opening closed shut by the spring behind it would open only when the internal pressure in the lance pipe reached 150 psi. This type of arrangement where the closed opening is opened when the pressure reaches a certain value is commonly known in the industry as a “Pressure Relief Valve (PRV)”.

The diluted liquid that was metered into the lance came out as a normally atomized intermittent spray; the spray would stop as soon as the pressure in the lance assembly dropped below 150 psi and would start again as soon as the pressure inside the lance assembly again went over 150 psi. At room temperature the atomized spray comes out as a liquid mist or atomized droplets.

### EXAMPLE 2

This lance assembly was put in hot gas where the gas temperature was around 360° F. After keeping the lance in the hot gas for some time the ARKAY chemical feed (diluted with water) was initiated. The lance pressure went up to around 155-160 psi momentarily then came back to 150 psi. This cycling between the pressures of 150 and 160 started to take place regularly. The lance-nozzle assembly was operated for several hours with the metering pump pumping the ARKAY formulation.

The addition of the chemical formulation was then terminated and only water was pumped through the lance-nozzle assembly for about a minute. The lance assembly was then removed from the hot gas, cooled and then the parts were disassembled. The lance assembly, the “PRV” assembly and the nozzle were found free from any dry form of the ARKAY formulation in them.

The pressure inside the lance assembly can also be raised to the desired level, in this case when feeding ARKAY formulation, by heating the lance assembly by an external means such as heating tape, by passing high temperature steam into an outer jacket of the coiled lance or by direct steam into which the diluted chemical would be injected but by utilizing appropriate check valves, etc.

From the above examples it will be obvious to those knowledgeable in the art of atomization that one can use other liquid solvents than water that is capable of going into vapor phase at suitable temperatures and pressures. It will also be obvious that the same can be employed to produce extremely fine size powder by exposing such an atomizing nozzle device into a chamber that is maintained at temperatures and pressures where the solvent goes into a vapor/gas phase.

What is claimed is:

1. A method to atomize liquids and solutions by
(i) first heating the liquid in a closed device above its boiling point, called herein as a process of superheating at above ambient pressures
(ii) releasing the pressure through a pressure relief valve into a device capable of allowing the superheated liquid to flow out through one or plurality of fine orifices into a chamber which is maintained at substantially lower pressure than the superheated fluid, called herein as de-superheating, and
(iii) letting the de-superheated fluid to expand and subdivide into atomized mist whereby the liquid substantially evaporates and the mist particle size becomes much smaller in dimension thus creating or leaving very fine atomized particles.

2. Wherein the liquid in claim 1 is water.

3. Wherein the liquid in claim 1 is inorganic solvents other than water.

4. Wherein the liquid in claim 1 is organic compounds.

5. Wherein the liquid is a fluid capable of becoming a liquid at above ambient pressures.

6. A method for producing ultra fine powder of materials soluble in a solvent that can be superheated and de-superheated in a way described in claim 1.

7. A method for producing ultra fine dry particles by utilizing the method described in claim 1 of materials soluble in liquids described in claims 2, 3, 4 or 5 above.

8. Method according to claim 1 for conditioning and treating flue gases for the removal of hazardous and toxic components present in them.
